(19) United States
(12) Patent Application Publication
(10) Pub. No.: US 2021/0294513 A1
(43) Pub. Date: Sep. 23, 2021

(54) MEMORY SYSTEM

(71) Applicant: SK hynix Inc., Gyeonggi-do (KR)

(72) Inventor: Jun Seop JEONG, Gyeonggi-do (KR)

(21) Appl. No.: 16/934,221

(22) Filed: Jul. 21, 2020

(30) Foreign Application Priority Data
Mar. 19, 2020 (KR) 10-2020-0033754

(51) Int. Cl. G06F 3/06; G06F 9/30

(52) U.S. Cl. CPC G06F 3/0647; G06F 3/0653; G06F 3/0659; G06F 9/30189; G06F 3/0614; G06F 3/0679; G06F 3/0629

(57) ABSTRACT

A memory system may include a plurality of nonvolatile memory apparatuses each comprising a plurality of memory regions; and a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group. The controller may be configured to store the first data in the first destination memory group in an order in which the first data is output from the nonvolatile memory apparatuses to the controller when a flag has been set with respect to the first source memory group.

### CROSS-REFERENCE TO RELATED APPLICATION

The present application claims priority under 35 U.S.C. § 119(a) to Korean application number 10-2020-0033754, filed on Mar. 19, 2020, in the Korean Intellectual Property Office, which is incorporated herein by reference in its entirety.

### BACKGROUND

### 1. Technical Field

Various embodiments generally relate to a memory system, and more particularly, to a memory system including a nonvolatile memory apparatus.

### 2. Related Art

A memory system may be configured to store data provided by a host apparatus in response to a write request from the host apparatus. Furthermore, the memory system may be configured to provide stored data to the host apparatus in response to a read request from the host apparatus. The host apparatus is an electronic device capable of processing data, and may include a computer, a digital camera or a mobile phone. The memory system may be embedded in the host apparatus or a separate component operably connected to the host apparatus.

### SUMMARY

An embodiment provides a memory system having improved performance of a migration operation.

In an embodiment, a memory system may include a plurality of nonvolatile memory apparatuses each comprising a plurality of memory regions; and a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group. The controller may be configured to store the first data in the first destination memory group in an order in which the first data is output from the nonvolatile memory apparatuses to the controller when a flag has been set with respect to the first source memory group.

In an embodiment, a memory system may include a plurality of nonvolatile memory apparatuses each comprising a plurality of memory regions; and a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group, and to perform a second migration operation of reading second data from a second source memory group and storing the second data in a second destination memory group. The controller may be configured to store the first data in the first destination memory group regardless of the order in which the first data has been stored in the first source memory group, when performing the first migration operation by determining the second destination memory group as the first source memory group.

In an embodiment, a memory system may include a plurality of nonvolatile memory apparatuses each comprising a plurality of memory regions; and a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group. The controller may be configured to store the first data in the first destination memory group regardless of an order in which the first data has been stored in the first source memory group when the first source memory group has a given state, and to store the first data in the first destination memory group based on the order when the first source memory group does not have the given state.

In an embodiment, an operating method of a controller for controlling a memory device having at least first and second memory groups may include flagging the first memory group when the first memory group becomes a destination memory group for a garbage collection operation; reading data pieces from the first memory group out to the controller; and programming the read data pieces from the controller into the second memory group. The read data pieces may be programmed in the same sequence as the data pieces are read out to the controller.

### BRIEF DESCRIPTION OF THE DRAWINGS

FIG. 1 is a block diagram of a memory system according to an embodiment.

FIG. 2 is a diagram illustrating a method of storing, by a controller, such as that of FIG. 1, data in a memory group according to an embodiment.

FIG. 3 is a diagram illustrating a method of performing, by a first migration component, a first migration operation according to an embodiment.

FIGS. 4A and 4B are diagrams illustrating a method of performing, by a second migration component, a second migration operation according to an embodiment.

FIG. 5 is a diagram illustrating a method of performing, by the first migration component, the first migration operation with reference to a flag according to an embodiment.

FIG. 6 is a flowchart illustrating a method of performing, by the first migration component, the first migration operation according to an embodiment.

FIG. 7 is a flowchart illustrating a method of performing, by the second migration component, the second migration operation according to an embodiment.

FIG. 8 is a diagram illustrating a data processing system including a solid state drive (SSD) in accordance with an embodiment.

FIG. 9 is a diagram illustrating a data processing system including a memory system in accordance with an embodiment.

FIG. 10 is a diagram illustrating a data processing system including a memory system in accordance with an embodiment.

FIG. 11 is a diagram illustrating a network system including a memory system in accordance with an embodiment.

FIG. 12 is a block diagram illustrating a nonvolatile memory device included in a memory system in accordance with an embodiment.

### DETAILED DESCRIPTION

Advantages and characteristics of this disclosure and methods of achieving them are described through embodiments with reference to the accompanying drawings. However, this invention is not limited to the embodiments described herein. Rather, features and aspects of the invention may be configured or arranged in other forms or ways, which may be variations or modifications of any of the disclosed embodiments. The present embodiments are provided to describe this invention in detail to the extent that a person skilled in the art may readily carry out and practice the invention.

In the drawings, embodiments of the present disclosure are not limited to specific forms illustrated in the drawings. Features and aspects may be exaggerated for clarity. Specific terms are used in the specification, but the terms are used only for descriptive purpose, not to limit the scope of the present invention.

In the specification, an expression “and/or” means at least one of the items listed. Furthermore, an expression that two elements are “connected/coupled” means that such elements may be directly or indirectly connected/coupled. In the specification, the singular form includes the plural form unless specially described otherwise. Furthermore, terms, such as “includes or comprises” and/or “including or comprising” used in the specification, mean the one or more other elements, steps, operations and/or devices identified, but do not preclude the existence or addition of other element(s), step(s), operation(s) and/or device(s). Also throughout the specification, reference to “an embodiment,” “another embodiment” or the like is not necessarily to only one embodiment, and different references to any such phrase are not necessarily to the same embodiment(s).

Hereinafter, embodiments are described in detail with reference to the accompanying drawings.

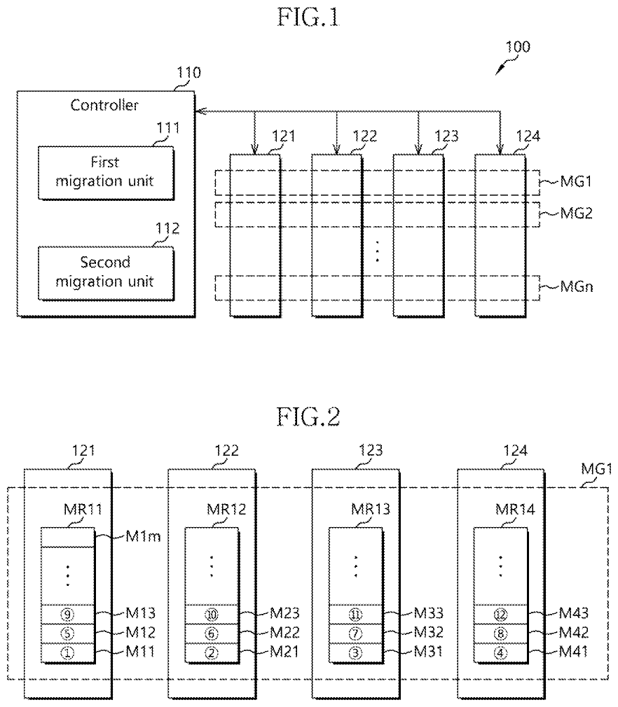

FIG. 1 is a block diagram of a memory system 100 according to an embodiment.

The memory system 100 may be configured to store data provided by an external host apparatus (host) in response to a write request from the host. Furthermore, the memory system 100 may be configured to provide stored data to the host in response to a read request from the host.

The memory system 100 may include a Personal Computer Memory Card International Association (PCMCIA) card, a Compact Flash (CF) card, a smart media card, a memory stick, various multimedia cards (MMC, eMMC, RS-MMC, and MMC-Micro), various secure digital cards (SD, Mini-SD, and Micro-SD), a Universal Flash Storage (UFS), and/or a Solid State Drive (SSD).

The memory system 100 may include a controller 110 and nonvolatile memory apparatuses 121 to 124.

The controller 110 may control overall operation of the memory system 100. The controller 110 may control the nonvolatile memory apparatuses 121 to 124 in order to perform a foreground operation in response to an instruction from the host. The foreground operation may include operations of writing data in one or more of the nonvolatile memory apparatuses 121 to 124 and reading data from one or more of the nonvolatile memory apparatuses 121 to 124 in response to instructions from the host, that is, a write request and a read request.

Furthermore, the controller 110 may control the nonvolatile memory apparatuses 121 to 124 in order to perform an internal background operation independently of the host. The background operation may be a wear-leveling operation, a garbage collection operation, an erase operation, a read re-claim operation, and/or a refresh operation for the nonvolatile memory apparatuses 121 to 124. Like the foreground operation, the background operation may include operations of writing data in one or more of the nonvolatile memory apparatuses 121 to 124 and reading data from one or more of the nonvolatile memory apparatuses 121 to 124.

The controller 110 may group memory regions, included in the nonvolatile memory apparatuses 121 to 124, into memory groups MG1 to MGn in order to access the nonvolatile memory apparatuses 121 to 124 in parallel. Each of the memory groups MG1 to MGn may include one or more memory regions included in each of the nonvolatile memory apparatuses 121 to 124.

The controller 110 may include a first migration component 111 and a second migration component 112.

The first migration component 111 may perform a first migration operation of reading first data from a first source memory group and storing the read data in a first destination memory group.

Specifically, when the first source memory group has a given (specific) state, the first migration component 111 may store the first data in the first destination memory group, regardless of the order in which the first data has been stored in the first source memory group. That is, the order in which the first data has been stored in the first source memory group may be different from the order in which the first data is stored in the first destination memory group. For example, the first migration component 111 may store the first data in the first destination memory group in the order in which the first data is output from the first source memory group to the controller 110.

When the first source memory group does not have a given state, the first migration component 111 may store the first data in the first destination memory group in the order in which the first data has been stored in the first source memory group.

The first source memory group may be determined based on a given selection condition among memory groups in which data has been stored. For example, the first migration component 111 may determine, as the first source memory group, a memory group having a read count that has reached a threshold. For example, the first migration component 111 may determine, as the first source memory group, a memory group in which hot data has been stored. The hot data may be data which is accessed frequently. For example, the first migration component 111 may determine, as the first source memory group, a memory group having an error rate that exceeds a threshold. The memory group having an error rate that exceeds a threshold may be a memory block that has almost reached the end of its life.

The first destination memory group may be determined among empty memory groups on which an erase operation has been performed.

In some embodiments, the first migration operation may include at least of a read re-claim operation, a refresh operation and a wear-leveling operation.

The second migration component 112 may perform a second migration operation of reading second data from a second source memory group and storing the second data in a second destination memory group.

Specifically, the second migration component 112 may store the second data in the second destination memory group, regardless of the order in which the second data has been stored in the second source memory group. For example, the second migration component 112 may store the second data in the second destination memory group in the order in which the second data is output from the second source memory group to the controller 110. As described above, the first migration component 111 performs the first migration operation based on a state of the first source memory group. In contrast, the second migration component 112 may perform the second migration operation, regardless of a state of the second source memory group.

When performing the second migration operation, the second migration component 112 may store information indicating that the second destination memory group has a given state, i.e., that it was the recipient of data in the second migration operation. In other words, when a memory group has a given state, that memory group stores data that was moved thereto through the second migration operation.

In some embodiments, the second migration component 112 may indicate a state of the second destination memory group using a flag. For example, when performing the second migration operation, the second migration component 112 may set a flag for the second destination memory group. A flag is merely one way of indicating the state of the second destination memory group. Other suitable ways may be used.

The second source memory group may be determined based on a given selection condition among memory groups in which data has been stored. The second migration component 112 may determine a memory group as the second source memory group based on a ratio of invalid data stored in the memory group. For example, the second migration component 112 may determine, as the second source memory group, a memory group in which a ratio of invalid data to all data stored therein exceeds a threshold. For example, the second migration component 112 may determine, as the second source memory group, a memory group in which a ratio of invalid data to all data stored therein is the highest. In another embodiment, the second migration component 112 may determine, as the second source memory group, a memory group having the lowest cost for performing the second migration operation.

The second destination memory group may be determined among empty memory groups on which an erase operation has been performed.

In some embodiments, the second migration operation may include a garbage collection operation.

Although not illustrated, the controller 110 may further include a buffer for temporarily storing data transmitted between the host and the nonvolatile memory apparatuses 121 to 124. The buffer may temporarily store the first data or second data read from the first source memory group or the second source memory group when the first migration operation or the second migration operation is performed.

The nonvolatile memory apparatuses 121 to 124 may store data transmitted by the controller 110, read stored data, and transmit the read data to the controller 110, under the control of the controller 110. The nonvolatile memory apparatuses 121 to 124 may be coupled to the controller 110 using the same data transmission line or may be separately coupled to the controller 110 using different data transmission lines.

The nonvolatile memory apparatus may include a flash memory, such as a NAND flash or a NOR flash, a Ferroelectrics Random Access Memory (FeRAM), a Phase-Change Random Access Memory (PCRAM), a Magnetoresistive Random Access Memory (MRAM), a Resistive Random Access Memory (ReRAM), or other suitable memory type.

The nonvolatile memory apparatus may include one or more planes, one or more memory chips, one or more memory dies or one or more memory packages.

FIG. 1 illustrates, by way of example, that the memory system 100 includes the four nonvolatile memory apparatuses 121 to 124, but the number of nonvolatile memory apparatuses included in the memory system 100 is not limited thereto.

FIG. 2 is a diagram illustrating a method of storing, by the controller 110 of FIG. 1, data in the memory group MG1 according to an embodiment.

Referring to FIG. 2, the nonvolatile memory apparatuses 121 to 124 may include memory regions MR11 to MR14, respectively. The memory region may be a unit by which the nonvolatile memory apparatus performs an erase operation, but the present invention is not limited thereto. Each of the memory regions MR11 to MR14 may include a plurality of memory units. For example, the memory region MR11 may include memory units M11 to M1m. The memory unit may be a unit by which the nonvolatile memory apparatus performs a write operation and read operation, but the present invention is not limited thereto.

The memory regions MR11 to MR14 may be included in the memory group MG1. FIG. 2 illustrates that the memory group MG1 includes one memory region in each of nonvolatile memory apparatuses. In some embodiments, however, the memory group MG1 may include two or more memory regions in one or more of nonvolatile memory apparatuses. In this case, each of the nonvolatile memory apparatuses 121 to 124 may access two or more memory regions included in the memory group MG1 in parallel, under the control of the controller 110.

The controller 110 may store data in the memory group MG1 in a given storage order so that the nonvolatile memory apparatuses 121 to 124 perform write operations in parallel. For example, the circled numbers associated with the memory units M11 to M13, M21 to M23, M31 to M33 and M41 to M43 may mean the order in which the controller 110 stores data in the memory group MG1. That is, the controller 110 may sequentially store data in the memory units M11, M21, M31, and M41, may sequentially store data in the memory units M12, M22, M32, and M42, and then, may sequentially store data in the memory units M13, M23, M33, and M43. For example, when the nonvolatile memory apparatuses 121 to 124 start write operations by sequentially receiving write commands for the memory units M11, M21, M31, and M41, respectively, the corresponding write operations may be performed in parallel.

The controller 110 may store, in a memory group, sequential data corresponding to consecutive logic addresses in the order of the logical addresses (sequential order). That is, the order in which the sequential data is stored may follow a sequential order. The reason for this is that a fast sequential read speed can be provided because the nonvolatile memory apparatuses 121 to 124 also perform read operations in parallel like write operations, when the controller reads the sequential data from the nonvolatile memory apparatuses 121 to 124 in the order in which the sequential data has been stored.

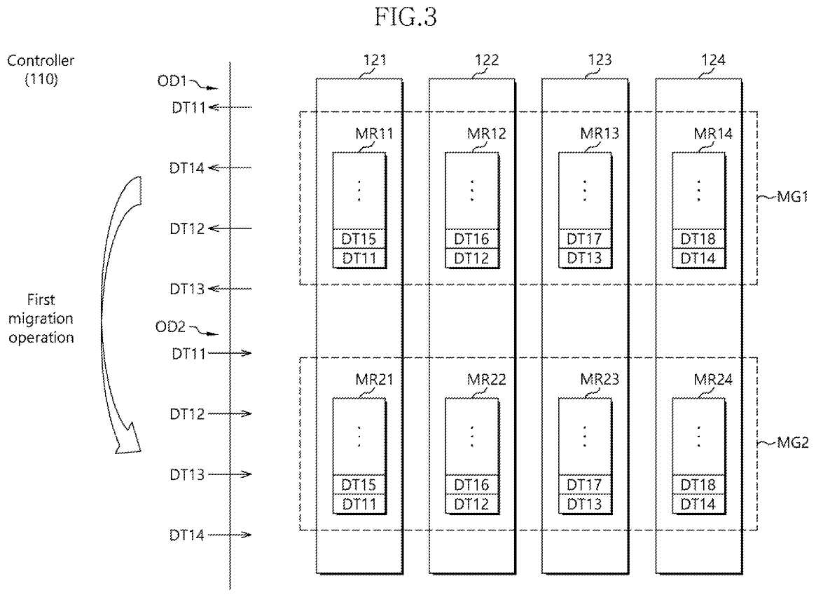

FIG. 3 is a diagram illustrating a method of performing, by the first migration component 111, the first migration operation according to an embodiment.

Referring to FIG. 3, the memory group MG1 may include the memory regions MR11 to MR14 in the nonvolatile memory apparatuses 121 to 124, respectively. The memory group MG2 may include memory regions MR21 to MR24 in the nonvolatile memory apparatuses 121 to 124, respectively. In some embodiments, nonvolatile memory apparatuses belonging to the memory group MG1 and nonvolatile memory apparatuses belonging to the memory group MG2 may be different.

The first migration component 111 may determine the memory group MG1 as a first source memory group, and may determine the memory group MG2 as a first destination memory group. The first migration component 111 may perform the first migration operation by reading data DT11 to DT18 from the first source memory group MG1 and storing the data DT11 to DT18 in the first destination memory group MG2.

The first migration component 111 may move, to the first destination memory group MG2, valid data stored in the first source memory group MG1, and may not move, to the first destination memory group MG2, invalid data stored in the first source memory group MG1. In FIG. 3, it is assumed that all the data DT11 to DT18 are valid data.

When the first source memory group MG1 does not have a given state, the first migration component 111 may move data from the first source memory group MG1 to the first destination memory group MG2 in the order in which the data has been stored in the first source memory group MG1. The data stored in the first destination memory group MG2 may maintain the same order as that in which the data was stored in the first source memory group MG1.

However, such a first migration operation may cause performance degradation in the memory system 100. Specifically, although the first migration component 111 sequentially transmits read commands to the nonvolatile memory apparatuses 121 to 124 in the order in which the data DT11 to DT14 were stored, as described with reference to FIG. 2, to read the data DT11 to DT14, the data DT11 to DT14 may be output from the first source memory group MG1 in output order OD1, for example. The reason for this is that the nonvolatile memory apparatuses 121 to 124 may have different read execution speeds or may have different transmission speeds for the controller 110. In this case, to store the data DT11 to DT14 in the first destination memory group MG2 in storage order OD2, the first migration component 111 may have to wait for the data DT12 and DT13 to be output without storing, in the first destination memory group MG2, the data DT14 output earlier than the data DT12 and DT13 from the first source memory group MG1. Such waiting may delay the completion of the first migration operation, causing performance degradation in the memory system 100.

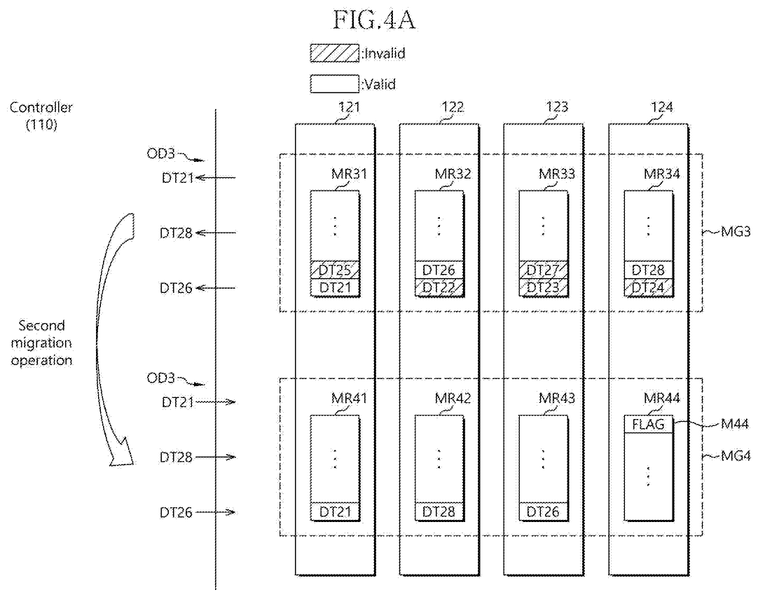

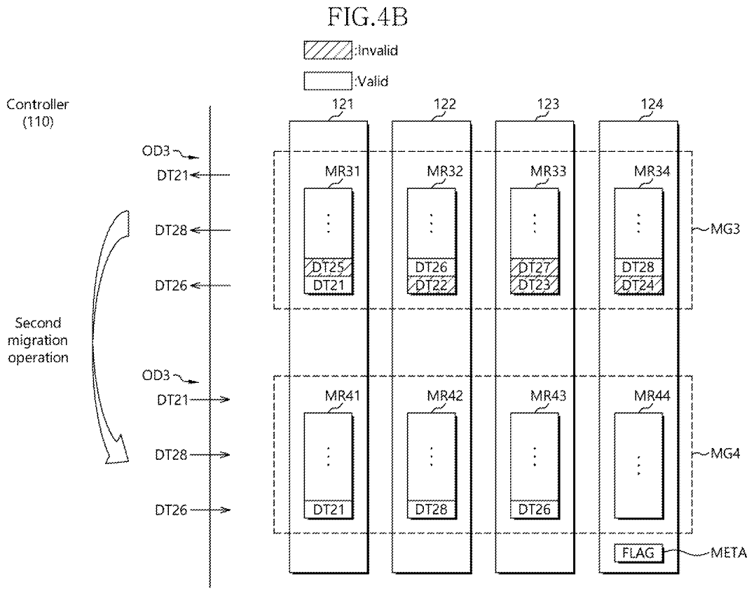

FIGS. 4A and 4B are diagrams illustrating a method of performing, by the second migration component 112, the second migration operation according to an embodiment.

Referring to FIG. 4A, the memory group MG3 may include memory regions MR31 to MR34 included in the nonvolatile memory apparatuses 121 to 124, respectively. The memory group MG4 may include memory regions MR41 to MR44 included in the nonvolatile memory apparatuses 121 to 124, respectively. In some embodiments, nonvolatile memory apparatuses belonging to the memory group MG3 and nonvolatile memory apparatuses belonging to the memory group MG4 may be different.

The second migration component 112 may determine the memory group MG3 as a second source memory group, and may determine the memory group MG4 as a second destination memory group. The second migration component 112 may perform the second migration operation by reading valid data DT21, DT26, and DT28 from the second source memory group MG3 and storing the read data DT21, DT26, and DT28 in the second destination memory group MG4.

As described above, the second migration component 112 may determine the second source memory group MG3 based on a ratio of invalid data to all data stored in the second source memory group MG3. When the second source memory group MG3 has a high ratio of invalid data, it may be meaningless to maintain, in the second destination memory group MG4, the same order in which the data is stored the second source memory group MG3. The reason for this is that if sequential data has been stored in the second source memory group MG3, it is difficult for data having moved to the second destination memory group MG4 to still be sequential.

Accordingly, the second migration component 112 may store, in the second destination memory group MG4, the data DT21, DT26, and DT28 read from the second source memory group MG3, regardless of the order in which the data DT21, DT26, and DT28 were stored in the second source memory group MG3. For example, the second migration component 112 may store the data DT21, DT28, and DT26 in the second destination memory group MG4 in order OD3 in which the data DT21, DT28, and DT26 are output from the second source memory group MG3.

Furthermore, the second migration component 112 may set a flag (FLAG) for the second destination memory group MG4. The flag may indicate that data stored in the second destination memory group MG4 is data having moved through the second migration operation.

As illustrated in FIG. 4A, the flag may be stored at a specific location (e.g., memory unit M44) of the second destination memory group MG4.

Referring to FIG. 4B, in some embodiments, the flag may be stored in a separate meta region META other than the second destination memory group MG4. The meta region META may be used by the controller 110 to store a variety of types of metadata.

FIG. 4B illustrates that the meta region META is located in the nonvolatile memory apparatus 124. In some embodiments, the meta region META may be located in the nonvolatile memory apparatus 121, 122 or 123.

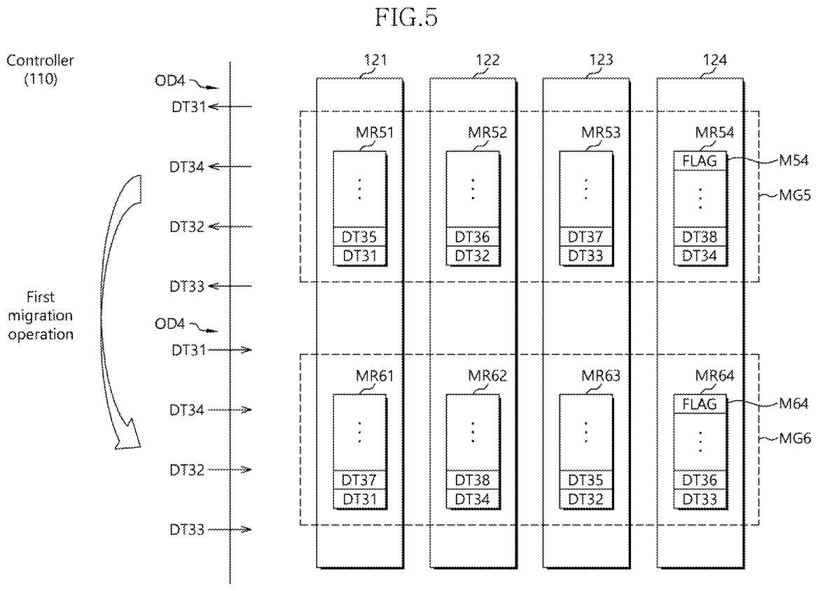

As described below with reference to FIG. 5, the first migration component 111 can improve performance of the first migration operation by performing the first migration operation based on the flag.

FIG. 5 is a diagram illustrating a method of performing, by the first migration component 111, the first migration operation with reference to the flag (FLAG) according to an embodiment.

Referring to FIG. 5, the memory group MG5 may include memory regions MR51 to MR54 included in the nonvolatile memory apparatuses 121 to 124, respectively. The memory group MG6 may include memory regions MR61 to MR64 included in the nonvolatile memory apparatuses 121 to 124, respectively. In some embodiments, nonvolatile memory apparatuses belonging to the memory group MG5 and nonvolatile memory apparatuses belonging to the memory group MG6 may be different.

The first migration component 111 may determine the memory group MG5 as a first source memory group, and may determine the memory group MG6 as a first destination memory group. The first migration component 111 may identify that the flag has been set in a memory unit M54 of the first source memory group MG5.

In this case, the first migration component 111 may store, in the first destination memory group MG6, data DT31 to DT38 read from the first source memory group MG5, regardless of the order in which the data DT31 to DT38 have been stored in the first source memory group MG5. For example, the first migration component 111 may store the data DT31, DT34, DT32, and DT33 in the first destination memory group MG6 in order OD4 in which the data DT31, DT34, DT32, and DT33 are output from the first source memory group MG5.

In some embodiments, the first migration component 111 may set the flag for the first destination memory group MG6. For example, the first migration component 111 may store the flag in a memory unit M64 of the first destination memory group MG6.

When the first migration component 111 identifies that the flag is not set in the first source memory group MG5, the first migration component 111 may perform the first migration operation as described with reference to FIG. 3.

In summary, if a second destination memory block for the second migration operation is the first source memory block MG5 for the first migration operation, the first migration component 111 may continue to neglect storage order even in the first migration operation because storage order in the second source memory block has already been neglected in the second migration operation. As in FIG. 3, the first migration component 111 may first store the data DT34 in the first destination memory group MG6 based on the output order OD4 without a need to wait for the data DT32 and DT33 not yet output to the controller 110. Accordingly, the first migration operation can be completed more rapidly because unnecessary waiting is eliminated.

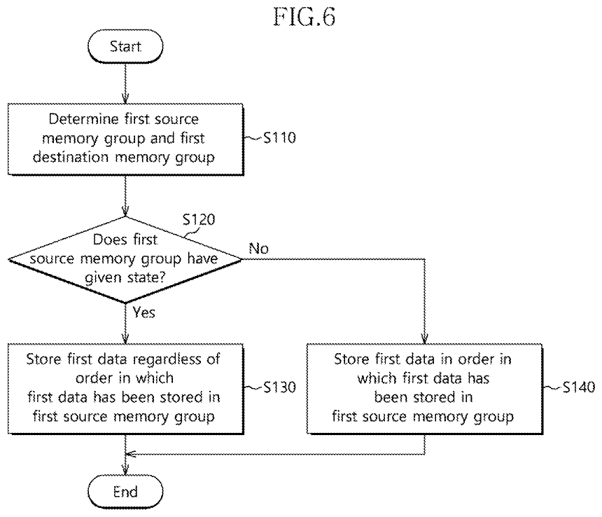

FIG. 6 is a flowchart illustrating a method of performing, by the first migration component 111, the first migration operation according to an embodiment.

Referring to FIG. 6, at operation S110, the first migration component 111 may determine a first source memory group and a first destination memory group.

At operation S120, the first migration component 111 may determine whether the first source memory group has a given state. For example, when a flag is set with respect to the first source memory group, the first migration component 111 may determine that the first source memory group has the given state. When the first source memory group has the given state, the procedure may proceed to operation S130. When the first source memory group does not have the given state, the procedure may proceed to operation S140.

At operation S130, the first migration component 111 may store, in the first destination memory group, first data read from the first source memory group, regardless of the order in which the first data has been stored in the first source memory group.

At operation S140, the first migration component 111 may store, in the first destination memory group, first data read from the first source memory group, in the order in which the first data has been stored in the first source memory group.

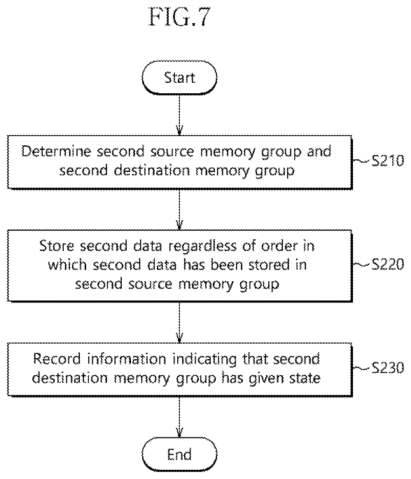

FIG. 7 is a flowchart illustrating a method of performing, by the second migration component, the second migration operation according to an embodiment.

Referring to FIG. 7, at operation S210, the second migration component 112 may determine a second source memory group and a second destination memory group.

At operation S220, the second migration component 112 may store, in the second destination memory group, second data read from the second source memory group, regardless of the order in which the second data has been stored in the second source memory group.

At operation S230, the second migration component 112 may record information indicating that the second destination memory group has a given state, which in this case indicates that the second destination memory group has data moved to it in the second migration operation.

The memory system according to an embodiment can perform a migration operation having improved performance.

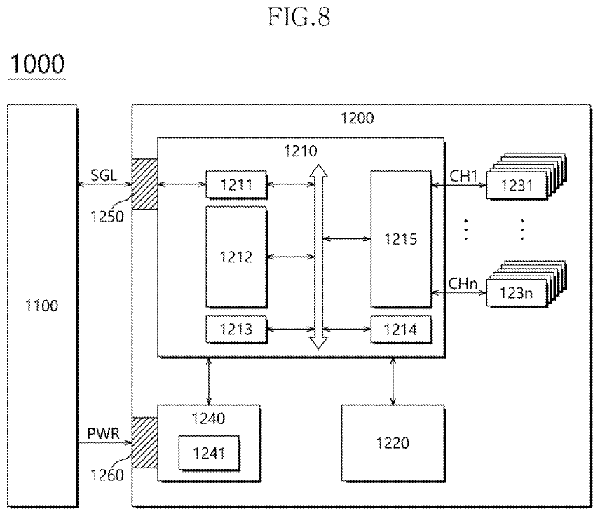

FIG. 8 is a diagram illustrating a data processing system 1000 including a solid state drive (SSD) 1200 in accordance with an embodiment. Referring to FIG. 8, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operation of the SSD 1200. The controller 1210 may include a host interface 1211, a control component 1212, a random access memory 1213, an error correction code (ECC) component 1214, and a memory interface 1215.

The host interface 1211 may exchange a signal SGL with the host device 1100 through the signal connector 1250. The signal SGL may include a command, an address, data, and the like. The host interface 1211 may interface the host device 1100 and the SSD 1200 according to the protocol of the host device 1100. For example, the host interface 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnect (PCI), PCI express (PCI-E) and/or universal flash storage (UFS).

The control component 1212 may analyze and process the signal SGL received from the host device 1100. The control component 1212 may control operations of internal function blocks according to firmware or software for driving the SSD 1200. The random access memory 1213 may be used as a working memory for driving such firmware or software.

The control component 1212 may include the first migration component 111 and the second migration component 112 shown in FIG. 1. The control component 1212 may operate in the same manner as the first migration component 111 and the second migration component 112 shown in FIG. 1.

The ECC component 1214 may generate the parity data of data to be transmitted to at least one of the nonvolatile memory devices 1231 to 123n. The generated parity data may be stored together with the data in the nonvolatile memory devices 1231 to 123n. The ECC component 1214 may detect an error of the data read from at least one of the nonvolatile memory devices 1231 to 123n, based on the parity data. If a detected error is within a correctable range, the ECC component 1214 may correct the detected error.

The memory interface 1215 may provide control signals such as commands and addresses to at least one of the nonvolatile memory devices 1231 to 123n, according to control of the control component 1212. Moreover, the memory interface 1215 may exchange data with at least one of the nonvolatile memory devices 1231 to 123n, according to control of the control component 1212. For example, the memory interface 1215 may provide the data stored in the buffer memory device 1220 to at least one of the nonvolatile memory devices 1231 to 123n, or provide the data read from at least one of the nonvolatile memory devices 1231 to 123n to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to the same channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be properly terminated when a sudden power-off occurs. The auxiliary power supply 1241 may include large capacity capacitors.

The signal connector 1250 may be configured by any of various types of connectors depending on an interface scheme between the host device 1100 and the SSD 1200.

The power connector 1260 may be configured by any of various types of connectors depending on a power supply scheme of the host device 1100.

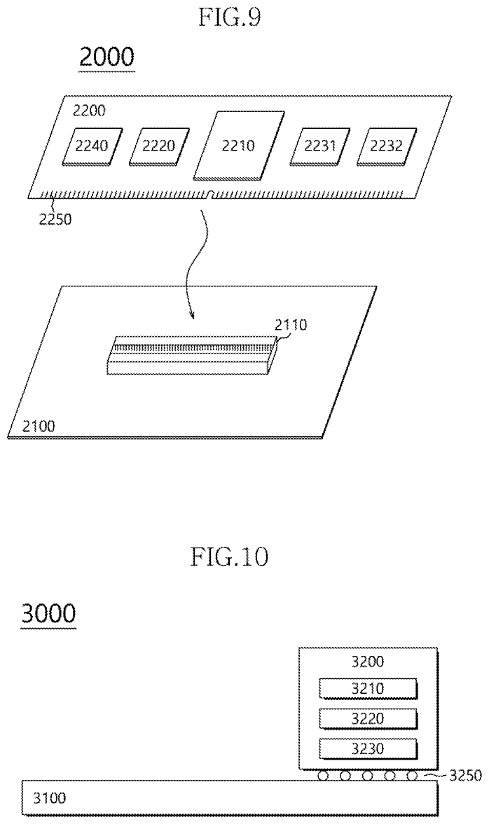

FIG. 9 is a diagram illustrating a data processing system 2000 including a memory system 2200 in accordance with an embodiment. Referring to FIG. 9, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operation of the memory system 2200. The controller 2210 may be configured in the same manner as the controller 1210 shown in FIG. 8.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power, inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and the like, as well as power, may be transferred between the host device 2100 and the memory system 2200. The connection terminal 2250 may be configured as any of various types depending on an interface scheme between the host device 2100 and the memory system 2200. The connection terminal 2250 may be disposed on or in any side of the memory system 2200.

FIG. 10 is a diagram illustrating a data processing system 3000 including a memory system 3200 in accordance with an embodiment. Referring to FIG. 10, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operation of the memory system 3200. The controller 3210 may be configured in the same manner as the controller 1210 shown in FIG. 8.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

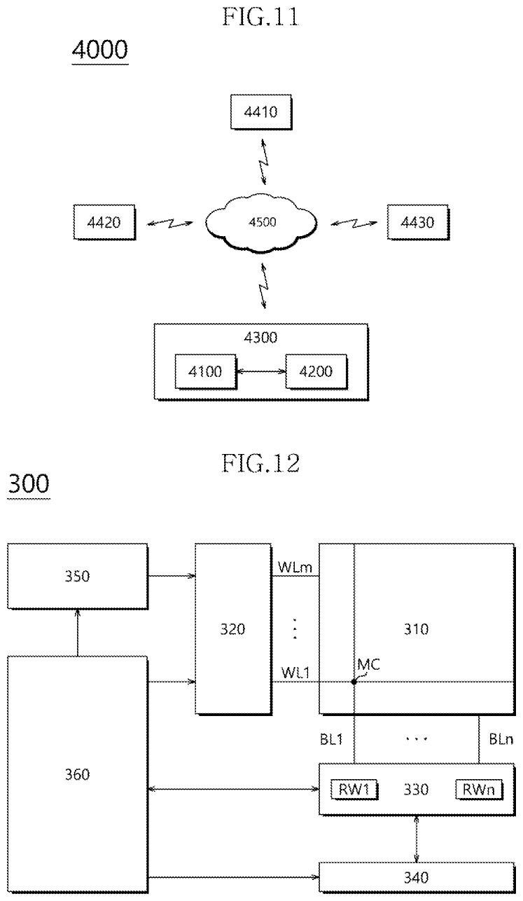

FIG. 11 is a diagram illustrating a network system 4000 including a memory system 4200 in accordance with an embodiment. Referring to FIG. 11, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 10 shown in FIG. 1, the SSD 1200 shown in FIG. 8, the memory system 2200 shown in FIG. 9 or the memory system 3200 shown in FIG. 10.

FIG. 12 is a block diagram illustrating a nonvolatile memory device 300 included in a memory system in accordance with an embodiment. Referring to FIG. 12, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operation of the nonvolatile memory device 300 based on control signals provided from the external device. For example, the control logic 360 may control operations of the nonvolatile memory device 300 such as read, write and erase operations of the nonvolatile memory device 300.

While the present invention has been illustrated and described in connection with specific embodiments, those skilled in the art to which this disclosure pertains should understand that the disclosed embodiments are merely examples and not limiting, as the present invention may be implemented in various other forms and ways without departing from the technical spirit and scope of the present invention. Accordingly, the scope of this invention is defined by the appended claims rather than by the detailed description. Moreover, the present invention encompasses all modifications and variations of any of the disclosed embodiments that fall within the scope of the claims.

What is claimed is:

1. A memory system comprising:
a plurality of nonvolatile memory apparatuses each comprising a plurality of memory regions; and
a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group,
wherein the controller is configured to store the first data in the first destination memory group in an order in which the first data is output from the nonvolatile memory apparatuses to the controller when a flag has been set with respect to the first source memory group.

2. The memory system of claim 1, wherein the controller is configured to store the first data in the first destination memory group in an order in which the first data has been stored in the first source memory group when the flag is not set with respect to the first source memory group.

3. The memory system of claim 1, wherein the controller is configured to perform a second migration operation of reading second data from a second source memory group and storing the second data in a second destination memory group in an order in which the second data is output from the nonvolatile memory apparatuses to the controller.

4. The memory system of claim 3, wherein the controller is configured to set the flag with respect to the second destination memory group when performing the second migration operation.

5. The memory system of claim 3, wherein the controller is configured to determine one of the memory groups as the second source memory group based on a ratio of invalid data to all data stored in the memory group.

6. The memory system of claim 1, wherein the controller is configured to set the flag with respect to the first destination memory group when the flag has been set with respect to the first source memory group.

7. A memory system comprising:
a plurality of nonvolatile memory apparatuses each comprising a plurality of memory regions; and
a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group, and to perform a second migration operation of reading second data from a second source memory group and storing the second data in a second destination memory group,
wherein the controller is configured to store the first data in the first destination memory group regardless of the order in which the first data has been stored in the first source memory group, when performing the first migration operation by determining the second destination memory group as the first source memory group.

8. The memory system of claim 7, wherein the controller is configured to store the first data in the first destination memory group in the order in which the first data is output from the first source memory group to the controller, when performing the first migration operation by determining the second destination memory group as the first source memory group.

9. The memory system of claim 7, wherein the controller is configured to:
set a flag with respect to the second destination memory group when performing the second migration operation, and
identify whether the flag has been set with respect to the first source memory group when performing the first migration operation.

10. The memory system of claim 9, wherein the controller is configured to set the flag with respect to the first destination memory group, when performing the first migration operation by determining the second destination memory group as the first source memory group.

11. The memory system of claim 7, wherein the controller is configured to determine one of the memory groups as the second source memory group based on a ratio of invalid data to all data stored in the memory group.

12. A memory system comprising:
is a plurality of nonvolatile memory apparatuses each comprising a plurality of memory regions; and
a controller configured to group the memory regions in the plurality of nonvolatile memory apparatuses into memory groups, such that each memory group includes at least one memory region from each of the plurality of nonvolatile memory apparatuses, the controller being further configured to perform a first migration operation of reading first data from a first source memory group and storing the first data in a first destination memory group,
wherein the controller is configured to store the first data in the first destination memory group regardless of an order in which the first data has been stored in the first source memory group when the first source memory group has a given state, and to store the first data in the first destination memory group based on the order when the first source memory group does not have the given state.

13. The memory system of claim 12, wherein the controller is configured to perform a second migration operation of reading second data from a second source memory group and storing the second data in a second destination memory group regardless of a state of the second source memory group and regardless of an order in which the second data has been stored in the second source memory group.

14. The memory system of claim 13, wherein the controller is configured to store information indicating that the second destination memory group has the given state, when performing the second migration operation.

15. The memory system of claim 13, wherein the controller is configured to determine one of the memory groups as the second source memory group based on a ratio of invalid data to all data stored in the memory group.

16. The memory system of claim 12, wherein the controller is configured to store information indicating that the first destination memory group has the given state, when the first source memory group has the given state.
